(19) United States
(12) Patent Application Publication
(10) Pub. No.: US 2026/0058817 A1
(43) Pub. Date: Feb. 26, 2026

(54) END TO END ENCRYPTION WITH ROAMING CAPABILITIES

(71) Applicant: Encstocom LLC, Grand Cayman (KY)

(72) Inventor: Paul HEINLEIN, Cantley (CA)

(21) Appl. No.: 19/377,602

(22) Filed: Nov. 3, 2025

Related U.S. Application Data
(63) Continuation-in-part of application No. 18/880,027.
(60) Provisional application No. 63/392,155, filed on Jul. 26, 2022.

(51) Int. Cl. H04L 9/32; H04L 9/08

(52) U.S. Cl. CPC H04L 9/3226; H04L 9/0863; H04L 9/3221

(57) ABSTRACT

Systems and methods relating to end to end encryption. Encrypted data stored on a server or transmitted by way of a server can be accessed from any number of authenticated client devices by storing an encrypted private key on the server. The encrypted data can only be decrypted by the decrypted version of the encrypted private key. The encrypted private key is undecryptable by the server and can only be decrypted using user provided credentials (e.g. a user provided password/passphrase). For the user to access the encrypted data, the client device used by the user downloads the encrypted private key along with the encrypted data. The encrypted private key is then decrypted using user provided credentials and the decrypted private key is used to decrypt the downloaded encrypted data. The decrypted private key never leaves the client device and is never used by the server.

### CROSS REFERENCE TO RELATED APPLICATIONS

This application is a Continuation-in-Part of U.S. application No. Ser. No. 18/880,027, filed on Dec. 30, 2024, entitled “END TO END ENCRYPTION WITH ROAMING CAPABILITIES”, which is a national stage filing under 35 U.S. C. § 371 of PCT Application No. PCT/CA2023/050570, filed on Apr. 27, 2023, entitled “END TO END ENCRYPTION WITH ROAMING CAPABILITIES”, which claims priority to U.S. Provisional Application No. 63/392,155, filed on Jul. 26, 2022, entitled “END TO END ENCRYPTION WITH ROAMING CAPABILITIES”, each of which are incorporated herein by reference in their entirety.

### TECHNICAL FIELD

The present invention relates to cryptography and secure communications. More specifically, the present invention relates to systems and methods for providing end to end encryption for multiple clients while preventing servers from accessing stored encrypted communications.

### BACKGROUND

The digital and communications revolution of the past two decades has highlighted not just the centrality of communications in the modern world but also the need for privacy. While we are now able to digitally converse with almost anyone in the world at our leisure, there is no guarantee that our communications are secure from eavesdropping. To this end, End-To-End Encryption was devised to allow users to securely communicate with one another digitally. Communications are encrypted and are only decrypted at a user's client device. Public key-private key pairs are used in such communications schemes, with a transmitting user encrypting communications at their client device using the public key. A receiving user then receives the encrypted communications and decrypts the encrypted communications using their private key at their client device.

However, while End-to-End Encryption (E2EE) is useful, current E2EE systems suffer from a significant drawback. The private keys used by End-To-End Encryption are typically generated and stored exclusively at only one client-side user end-point. No other end-points used by the same client have access to the private key, and therefore cannot decrypt any server-side stored or relayed data that was encrypted using the public key that is paired to it. This creates a problem for the user if they need to switch end-points (i.e. switching from mobile device to workstation, replacing a lost device, etc.) because they will lose the ability to read server-stored data and cause disruptions to on-going communications. If the E2EE private key could be stored server-side, this will allow it to be shared with new and existing end-points that belong to the client, but unless this can be done in a secure way it will defeat the whole purpose of using E2EE because the operator of the system could simply reset the account password to gain access to old and new client data. Even if the client encrypted the private key client-side with the account passphrase before storing the result server-side, it would still be vulnerable because the passphrase when being used over TLS during authentication could still be intercepted server-side.

Because of the above, there is therefore a need for systems and methods that allow for secure E2EE communications and which also allow users to securely switch client devices or end-point devices without losing access to their secure communications.

### SUMMARY

The present invention provides systems and methods relating to end to end encryption. Encrypted data stored on a server or transmitted by way of a server can be accessed from any number of authenticated client devices by storing an encrypted private key on the server. The encrypted data can only be decrypted by the decrypted version of the encrypted private key. The encrypted private key is undecryptable by the server and can only be decrypted using user provided credentials (e.g. a user provided password/passphrase). For the user to access the encrypted data, the client device used by the user downloads the encrypted private key along with the encrypted data. The encrypted private key is then decrypted using user provided credentials and the decrypted private key is used to decrypt the downloaded encrypted data. The decrypted private key never leaves the client device and is never used by the server.

In a first aspect, the present invention provides a method for accessing encrypted data using a client device, said encrypted data being transmitted from a server to said client device, the method comprising:
undergoing a login and authentication process to thereby authenticate a user and said client device to said server, said login and authentication process involving a user first password;
receiving an encrypted private key from said server at said device;
decrypting said encrypted private key at said client device using a private key decryption key, said private key decryption key being derived from a user second password and from at least one user identification element;
receiving said encrypted data from said server;
decrypting said encrypted data using said decrypted private key;
   wherein
said user first password and said user second password are only available to said user;
said encrypted private key is undecryptable by said server;
said encrypted private key can only be decrypted using said private key decryption key;
said decrypted private key is only ever used by said client.

In a second aspect, the present invention provides a method for accessing encrypted data by way of a server, said encrypted data being transmitted from said server to a client device, the method comprising:
authenticating a user and said client device to said server;
at said client device, receiving an encrypted private key from said server, said encrypted private key being previously stored on said server by said user;
decrypting said encrypted private key at said client device using a private key decryption key to result in a decrypted private key, said private key decryption key being derived from user supplied credentials;
receiving said encrypted data from said server;
decrypting said encrypted data using said decrypted private key;
   wherein
said encrypted private key is undecryptable by said server;
said encrypted private key can only be decrypted using said private key decryption key;
said decrypted private key is only ever used by said client.

In a third aspect, there is provided a method for accessing encrypted data using a client device, said encrypted data being transmitted from a data server to said client device, the method comprising:
receiving user credentials, said user credentials including at least one user password;
deriving a first password from said user credentials;
undergoing a login and authentication process to thereby authenticate a user and said client device to a server, said login and authentication process involving said first password;
receiving an encrypted private key from said server at said device;
decrypting said encrypted private key at said client device using a private key decryption key, said private key decryption key being derived from said user credentials;
receiving said encrypted data from said data server;
decrypting said encrypted data using said decrypted private key;
   wherein
said user first password and said at least one user password are only available to said user;
said encrypted private key is undecryptable by said server;
said encrypted private key can only be decrypted using said private key decryption key;
said decrypted private key is only ever used by said client device.

In a fourth aspect, the present invention provides a method for accessing encrypted data by way of a server, said encrypted data being transmitted from a data server to a client device, the method comprising:
receiving user supplied credentials, said user supplied credentials including at least one user password;
deriving a first password from said user credentials;
authenticating a user and said client device to said server using said first password by way of a zero-knowledge login and authentication process;
at said client device, receiving an encrypted private key from said server, said encrypted private key being previously stored on said data server by said user;
decrypting said encrypted private key at said client device using a private key decryption key to result in a decrypted private key, said private key decryption key being derived from said user supplied credentials;
receiving said encrypted data from said server;
decrypting said encrypted data using said decrypted private key;
   wherein
said encrypted private key is undecryptable by said server;
said encrypted private key can only be decrypted using said private key decryption key;
said decrypted private key is only ever used by said client device.

In yet another aspect, the present invention provides a method for using user supplied credentials for authentication and decryption, the method comprising:
receiving user supplied credentials, said user supplied credentials including at least one user password;
deriving a first password from said user supplied credentials;
authenticating a user and said client device to a server using said first password by way of a login and authentication process;
at said client device, deriving a private key decryption key from said user supplied credentials and decrypting an encrypted private key using said private key decryption key, said encrypted private key being downloaded to said client device from said server;
   wherein
said encrypted private key is undecryptable by said server;
said encrypted private key can only be decrypted using said private key decryption key;
said decrypted private key is only ever used by said client device.

As another aspect, the method involves at least one or more of:
two-factor authentication (2FA);
one-time token (OTT);
a single sign-on (SSO) method;
a single sign-on (SSO) method using user supplied credentials to create a session for a user device;
Human Interactive Proof (HIP);
a Turing Test being used to prove that a user is human; and
a salt provided by a server for use by a client during a hashing process.

In a further aspect, the present invention provides computer readable media having encoded thereon computer readable and computer executable code that, when executed, implements a method for accessing encrypted data by way of a server, said encrypted data being transmitted from said server to a client device, the method comprising:
authenticating a user and said client device to said server;
at said client device, receiving an encrypted private key from said server, said encrypted private key being previously stored on said server by said user;
decrypting said encrypted private key at said client device using a private key decryption key to result in a decrypted private key, said private key decryption key being derived from user supplied credentials;
receiving said encrypted data from said server;
decrypting said encrypted data using said decrypted private key;
   wherein
said encrypted private key is undecryptable by said server;
said encrypted private key can only be decrypted using said private key decryption key;
said decrypted private key is only ever used by said client.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of an environment on which the present invention can be practiced;

FIG. 2 is a block diagram illustrating the components used in one implementation of the present invention;

FIG. 3 is a block diagram illustrating a communications system that implements one aspect of the present invention; and

FIG. 4 is a flowchart detailing the steps in another aspect of the present invention.

### DETAILED DESCRIPTION

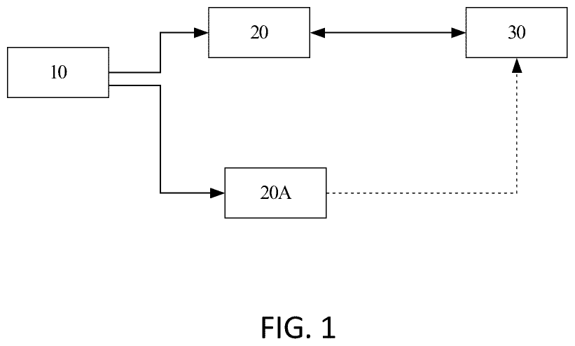

Referring to FIG. 1, a block diagram of an environment in which the present invention may be practiced is presented. In this scenario, a user 10 is using a client device 20 that communicates with a server 30. The user and the client device have already been logged in and authenticated and the user has uploaded encrypted data 40 to the server 30 and wishes to access this stored data using E2EE. As noted above, while this is possible using client device 20, trying to do this from another client device 20A may be difficult using current technology.

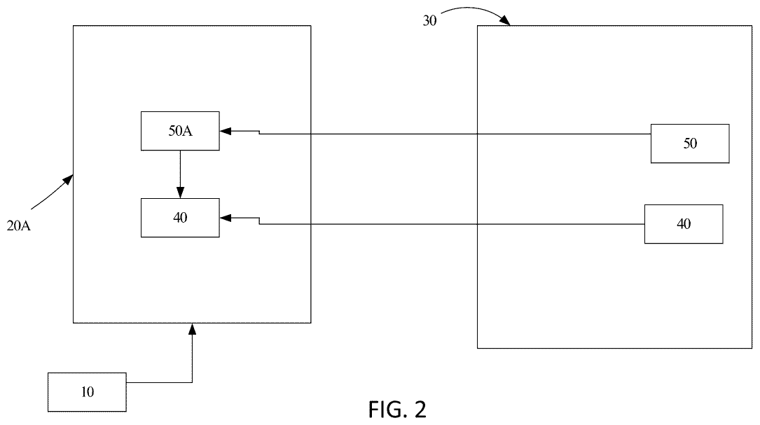

Referring to FIG. 2, one aspect of the present invention is illustrated. In the present invention, the user 10 can access the encrypted data 40 from client device 20A by having client device 20A authenticated and logged in to server 30. The user 10 then downloads an encrypted private key 50 that has been previously stored on server 30. The encrypted data 40 can only be decrypted by a decrypted version of the encrypted private key 50 and the encrypted private key 50 can only be decrypted by the client device 20A using a unique password/decryption passphrase from the user. The user thus downloads encrypted private key 50 to client device 20A, decrypts the encrypted private key on client device 20A, and then downloads the encrypted data 40. The encrypted data 40 can then be decrypted using the decrypted private key 50A. It should be noted that the server 30 does not have the ability to decrypt or cannot decrypt the encrypted data 40 or the encrypted private key 50. As well, the decrypted version of the private key 50A never leaves either client device 20A or client device 20. This ensures that the server 30 cannot access the encrypted data 40.

The above aspect of the present invention allows a user to use E2EE on multiple client devices while ensuring that the server (or any other potential eavesdropper) is unable to access the stored encrypted data.

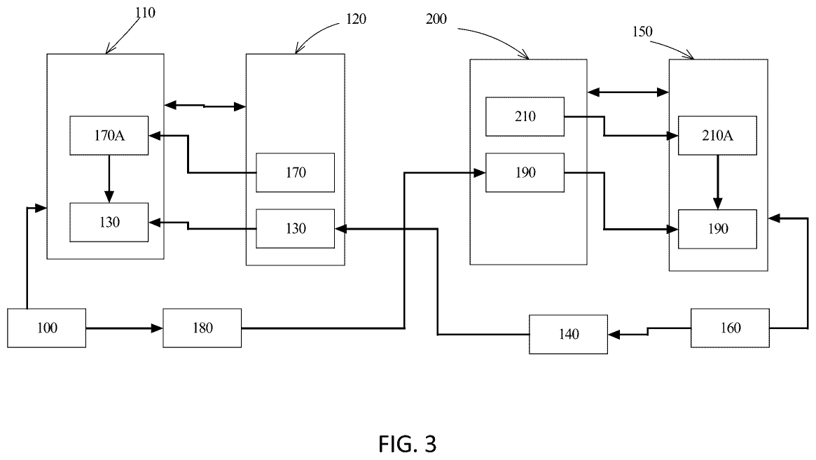

The various aspects of the present invention can also be used to ensure E2EE when communicating between different users across a communications medium with intervening servers. Referring to FIG. 3, this aspect of the present invention is illustrated in the block diagram. For this scenario, a first user 100 operates a first client device 110 to access a first server 120. Stored in the first server 120 is first encrypted data 130 encrypted using first user's public key 140 by way of second client device 150 operated by second user 160. Assuming the first user 100 has been authenticated and logged in to first server 120, first user can download first encrypted data 130 to first client device 110 as well as first encrypted private key 170. The user then decrypts first encrypted private key 170 to result in decrypted private key 170A on the first client device 110. This decrypted private key 170A corresponds to the first user's public key 140 and can thus be used to decrypt the downloaded first encrypted data 130. The first user 100 can thus decrypt the first encrypted data 130 using the decrypted private key 170A on the first client device 110. As the decrypted private key 170A never leaves the first client device 110 and as only the decrypted private key 170A is the only key that can decrypt the first encrypted data 130, the first server 120 has no access to the data in the first encrypted data 130. It should be clear that the first encrypted private key 170 is only decrypted with a password or decryption key that only the first user 100 can provide. This ensures that none of the other components in the communications system (and none of the other users of the communications system) can decrypt the first encrypted private key 170. Accordingly, none of the users or components of the system can access or decrypt the first encrypted data 130 without the first user's assistance.

On the other side of the communications system, the second user 160 also has a corresponding public key 180 that the first user 100 can use to encrypt data meant for the second user. This second encrypted data 190, encrypted using the public key 180, is transmitted and stored on the second server 200. The second user 160, also authenticated and logged in to second server 200 by way of the second client device 150, can access the second encrypted data 190 by downloading this second encrypted data 190 and a second encrypted private key 210. The second encrypted private key 210 can be downloaded on to the second client device 150 and be decrypted into the second decrypted private key 210A. This second decrypted private key 210A corresponds to the public key 180 and can be used to decrypt the second encrypted data 190. The second decrypted private key 210A cannot be decrypted without assistance or a password or passkey obtained from the second user 160. Accordingly, as with the first side of the communications system, none of the users of the system can access the data in the second encrypted data 190 without first decrypting the second encrypted private key 210. And, as this cannot be done without the assistance or input of the second user 160, the system is secure for communications going either from first user 100 to second user 160 or from second user 160 to first user 100. At this end of the system, the second server 200 cannot access the data in second encrypted data 190 nor can the second server 200 decrypt the second encrypted private key 210.

As can be imagined, communications from first user 100 to second user 160 is encrypted using the second user's public key and is decrypted using the decrypted second private key. Communications from the second user 160 to the first user 100 are encrypted using the first user's public key and are decrypted using the decrypted first private key. Since neither of the two servers is able to access either decrypted private keys, and since neither of the decrypted private keys ever leaves a client device, the system is secure. Preferably, the decrypted private keys are only ever used to decrypt the encrypted data and only on a client device.

For greater security, the key to decrypt encrypted private key can be derived from a user provided keyword along with user provided identification credentials. The greater security results from adding a form of salt to the hashing (as will be explained further below). After the hashing, the resulting password should be so unique that it will not be susceptible to dictionary attacks. As an example of the above, instead of just using a user provided keyword as the decryption key to decrypt the encrypted private key, the decryption key can be derived from a combination of parts of the user's identification credentials in addition to the keyword. Thus, a decryption key can be derived from a concatenation of parts of any combination of the user's email address, telephone number, username, and the keyword. The resulting concatenation can then be run through a non-reversible hashing process that produces the decryption key. Thus, for example, a user may have identification credentials as follows:
Username: AUser
Email address: AUser@emaildomain.com
Telephone number: 818-555-1212
Keyword: 12ab34cd56ef.

For such a user, an example concatenated string that can then be hashed to produce the decryption key may be:
AUs+AUser@email+818555+12ab34cd56ef
   where the + is the concatenation operator. Of course, any combination of any of the user's identification credentials can be used to create the value that is hashed to produce the decryption key. As well, while the example only used part of each of the identification credentials, any combination of such credentials may be used. As noted above, it is preferable if the result of a non-reversible hashing of the concatenated string/value is used as the decryption key.

In another example, using the user credentials given above, another suitable basis for a decryption key may be
{user phone_number}+{keyword}+{app_passphrase_for_private_key}

For clarity, the “passphrase_for_private_key” is a hard-coded string (a passphrase) in the client software and would be the same for everyone using that specific implementation. Such passphrases would be generated by the company writing the software implementation (similar to a root certificate for a certificate authority). The same passphrases would be used by all client software using the same implementation. Depending on the implementation, there could be one passphrase for the decryption key and there could be a different passphrase for the login/authentication password. The passphrases act as a form of salt that makes the hashes more non-reversible against a dictionary attack as the dictionary will need to be implementation specific and therefore unfeasible. For some implementations, two passphrases are used to generate different results depending on use - one passphrase could be used to generate the private key decryption key while another different passphrase could be used to generate login/authentication password as explained below.

Using the credentials and the decryption key scheme given above, the decryption key would thus be:
818555121212ab34cd56ef+[passphrase]
   and this resulting string/value can then be run through the one-way hashing process to result in the decryption key.

In another alternative, for ease of use for the user, the credentials provided by the user for a proper login are, preferably, just the user's password and another credential (e.g. a user's userID, email address, or phone number). The user's password and the other credential can then be combined to produce a string/value that can be hashed. The result of the one way hashing process can thus be the decryption key noted above. Of course, a passphrase may also be incorporated into this process as explained above.

As noted above, in addition to the above concatenated string value (with or without a passphrase), a one way hash function is preferably applied to the string value and the resulting hash value would be the decryption key used to decrypt the encrypted private key. It should be clear that encrypting the private key prior to storing the encrypted private key on the server would be necessary. In terms of the encryption key, this may not matter as long as the encrypted private key can be decrypted using the user supplied identification credentials and the user provided keyword. Thus, the encryption/decryption may be symmetric (using the same encryption/decryption key) or asymmetric (using an encryption key that is different from the decryption key) as long as the resulting encrypted private key can be decrypted with the user supplied credentials.

For added security, the login and authentication process that a user has to undergo to login and get authenticated by a server is, preferably, separate and independent from the process relating to downloading either the encrypted private key or the encrypted data from the server. The login and authentication process can involve a password that, again, is derived from user supplied credentials as well as a user supplied keyword. As with the decryption key noted above, the login and authentication password may be derived from the user credentials and user supplied keyword but, as may be imagined, is different from the decryption key noted above. The generation of the authentication password may, of course, involve the use of a passphrase as detailed above. As previously noted, the passphrase would be generated by the software developers involved in producing the application and may be different from the passphrase used to generate a decryption key.

As an example of the above, instead of the concatenated key detailed above, a login/authentication password may be produced from (using the user credentials above and prior to passing the result through a one way hashing process):
Use+Emaildomain+555+12ab34cd56ef
   As with the example above, the + is a concatenation operator. It can be seen that the basis for the decryption key (prior to the hashing process) is derived by using the first few characters of each user credential while the pre-hashing basis for the login/authentication password is derived by using the middle portions of each user credential. The only exception would be the user keyword as the whole keyword is used in both instances. As detailed above, the resulting string from the user credentials are passed through a non-reversible hashing process and the result from the hashing process would be used as the decryption key or as the login password. The process may, of course, also use a passphrase prior to the hashing process as explained above.

As noted above with the decryption key, instead of the actual generated string from the user credentials, the login/authentication password is the result of a one-way hash of the generated string from the credentials. This resulting password may be used to authenticate the user and the client device to the server. This way, no password or credentials are ever exchanged or transmitted in clear between the client device and the server.

While the above login/authentication process and the decryption key uses a single user provided keyword, one alternative would be for the user to use different keywords for the login/authentication process and for the decryption key. In yet another alternative, a single master password is derived from all of the user credentials entered, including the user provided keyword. A hash of this single master password is created and half of the resulting hash may be used as the login/authentication password while the other half of the resulting hash may be used as the decryption key.

As an alternative to using the result from a one-way hash for the login/authentication password and decryption key, the string from the credentials could, instead of being processed through hashing, be encrypted. To make this more difficult to reverse or decrypt, and to ensure that the process is a one-way process, the same string could be used as the key for encrypting the string. The result from encrypting the string can then be used as the login/authentication password or decryption key. As an alternative, after the encryption, half of the resulting string could be used as the login/authentication password while the other half is used as the decryption key.

One advantage of the various aspects of the present invention is that it allows a user to be able to access his or her data from any client device that is compliant to the present invention. That is, E2EE can be had by any client device that is logged in and authenticated to the server. The client device can then download the encrypted private key and, using the user entered credentials, can decrypt the encrypted private key. The decrypted private key can then be used to decrypt the encrypted data received from the server.

In one implementation, further security may be had by placing the encrypted data in an RSA/AES envelope. For non-reversible or one-way hash functions which may be used with the various aspects and implementations of the present invention, SHA512 may be used.

In a variant of the present invention, the concept of E2EE and the concepts in the present invention can be expanded to be used with ZK (zero-knowledge) authentication. As is known, zero-knowledge authentication derives from the concept of the zero-knowledge proof, the method of proving the validity of a statement without revealing anything other than the validity of the statement itself.

As noted above, the various aspects of the present invention can include the use of a master password that is derived from the user supplied credentials. This single master password may be derived from all of the user credentials entered, including a single user provided keyword. The ZK authentication process can then use a password derived from the user supplied credentials to authenticate a user and a user device to a server. The user supplied credentials may, of course, only include a single keyword or these credentials may include multiple user supplied keywords. Once the user/user device has been authenticated/logged in to a server using the ZK authentication process (and using a user credential derived password), the user device can download the encrypted private key for the encrypted data. The encrypted private key can, in one aspect of the present invention, be decrypted by the same user-credential-derived password used to login/authenticate using the ZK authentication process. Of course, as an alternative, the password used to decrypt the downloaded encrypted private key may be a different (but still derived from the user supplied credentials) password from that used to login/authenticate the user/user device.

As another variant, it should be noted that, from the above description, a server stores the encrypted private key that, when decrypted, allows for the decryption of stored encrypted data. It should be clear that the server storing the encrypted private key and the stored encrypted data may be different servers, with none of the servers involved being able to decrypt and of the encrypted private key or the stored encrypted data. Thus, assuming server A stores the encrypted private key and server B stores the stored encrypted data, different authentication processes may need to be used to authenticate a user/user device to one or both these servers. And, to further extend the concept, the authentication passwords necessary to authenticate a user/user device to these servers may be different (e.g., password XYZ is necessary to authenticate to server A while password QRX is necessary to authenticate to server B), with all the authentication passwords being derived from the user supplied credentials.

As a further variant of the above noted scheme, server A, storing the encrypted private key necessary to decrypt the stored encrypted data, may store the provider/location where the stored encrypted data is stored, along with any credentials or session keys necessary to facilitate access to the stored encrypted data (e.g., the server B storage address along with session keys and other credentials necessary to access server B, but NOT the authentication password for server B). As such, if a user is unable to access server A, then that user cannot access (or even know the location/address of) server B.

It should be noted that the use of session keys allows the user/user device to be logged in/authenticated to a server for extended periods without the need for re-authentication. Of course, the use of a session key also allows that user/user device to be forcibly logged out from the server if necessary. It should be clear that the use of session tokens or session keys may involve the use of Single Sign-On (SSO) authentication methods and may involve similar/related or adjacent technologies such as Kerberos, OAuth 2.0, OpenID Connect, SAML (Security Assertion Markup Language), NTLM (New Technology LAN Manager), and JWT (JSON Web Token).

Yet another variant allows for the division of the stored encrypted data. For this variant, there may be multiple sets of stored encrypted data A1, A2, A3, each of which can be decrypted using keys K1, K2, K3, respectively. These keys are decryptable using a main private key PK that is, also, encrypted. Thus, for a user to access stored encrypted data A1, the user has to:
a) Download Encrypted Pk
b) decrypt PK (using a password derived from user supplied credentials)
c) download encrypted K1
d) decrypt K1 using decrypted PK (the decryption may, depending on implementation, also use part of data derived from user supplied credentials)
e) download A1
f) decrypt A1 using decrypted K1 (again, the decryption may use part of data derived from the user supplied credentials).

As can be seen, as much as possible, the user supplied credentials (which never leave the user device) are used in the process to access the stored encrypted data A1. The scheme is also flexible in that, in the event PK is compromised or needs re-encryption, instead of re-encrypting the data A1, A2, A3, one simple has to re-encrypt the keys K1, K2, K3 using the new PK. Similarly, if the user wants to remove the data A1, instead of waiting for the server to delete the actual data A1, the user simply has to delete K1. This would remove any access to A1.

As a further enhancement to the various aspects of the present invention, the various servers may provide salt to be used by the client during the hashing process during any of: authentication, two-factor authentication (2FA), a process involving Human Interactive Proof (HIP, e.g., reCAPTCHA, hCaptcha, BotDetect), and during authentication without a session key. For clarity, the salt may also be used in the hashing process involved in any Turing Test used to prove that a user is human.

Examples of applications/processes that use 2FA may include email, SMS, OTP, and the use of security tokens. As well, a one-time token (OTT) may be used in an anti-spoof challenge (e.g. during data exchanges between servers and the user/user device to prevent packet spoofing). A nonce is an example of such an OTT.

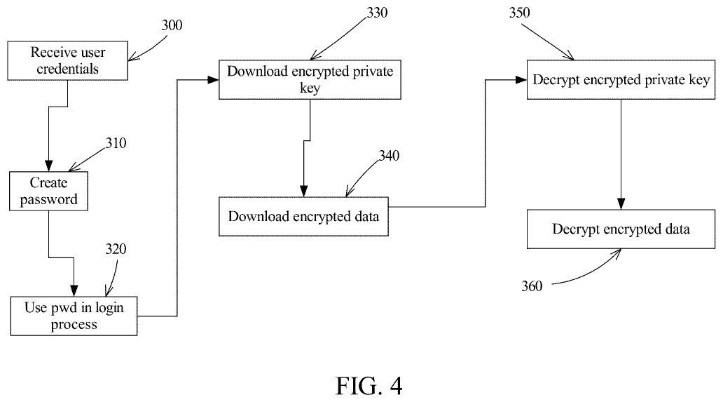

Referring to FIG. 4, a flowchart detailing the steps in a method according to another aspect of the present invention is illustrated. The method starts at step 300, that of receiving user credential input at the client device from the user. The credential input may include the user's username, email, telephone number, and at least one keyword. The next step is that of creating a login/authentication password from the user entered credentials (step 310). The login/authentication password is then used in a login/authentication process (step 320) that logins in and authenticates the user and the client device to the server. Once the login and authentication process is complete, step 330 is that of downloading the encrypted private key from the server to the client device. Step 340 then downloads the encrypted data from the server. This encrypted data may be data stored in the server by the user or it may be incoming data from another user. This encrypted data can only be decrypted using the decrypted version of the encrypted private key. Step 350 is that of decrypting the encrypted private key using a decryption key derived from the user entered credentials. As noted above, the generation of the decryption key may involve generating a one way hash and/or concatenating various parts of the different user credentials entered. Once the private key has been decrypted using the decryption key, the encrypted data is then decrypted using the decrypted private key (step 360).

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed:

1. A method for accessing encrypted data using a client device, said encrypted data being transmitted from a data server to said client device, the method comprising:
receiving user credentials, said user credentials including at least one user password;
deriving a first password from said user credentials;
undergoing a login and authentication process to thereby authenticate a user and said client device to a server, said login and authentication process involving said first password;
receiving an encrypted private key from said server at said device;
decrypting said encrypted private key at said client device using a private key decryption key, said private key decryption key being derived from said user credentials;
receiving said encrypted data from said data server;
decrypting said encrypted data using said decrypted private key;
wherein
said user first password and said at least one user password are only available to said user;
said encrypted private key is undecryptable by said server;
said encrypted private key can only be decrypted using said private key decryption key;
said decrypted private key is only ever used by said client device.

2. The method according to claim 1, wherein said encrypted data is encrypted by a public key that corresponds to said private key.

3. The method according to claim 1, wherein said first user password and said at least one user password are derived from a master password, said master password only being available to said user.

4. The method according to claim 1, wherein said authentication process is a zero-knowledge authentication process.

5. The method according to claim 1, wherein said data server and said server are different servers.

6. The method according to claim 1, wherein said user credentials only includes one user password.

7. The method according to claim 4, wherein a password used in said zero-knowledge authentication process is also used to decrypt said encrypted private key.

8. The method according to claim 1, wherein client device access to said server and said data server requires different authentication passwords, each of said different authentication passwords being derived from said user credentials.

9. The method according to claim 1, wherein said server provides a link to said data server.

10. The method according to claim 9, wherein said server provides said user with resources necessary to access said data server such that said user needs access to said server to access said data server.

11. The method according to claim 1, wherein said encrypted data comprises multiple sets of encrypted data, each set of encrypted data being decryptable by different decryption keys, each of said different decryption keys being encrypted and stored on said server.

12. The method according to claim 11, wherein each of said different decryption keys is decryptable by a decrypted version of said encrypted private key.

13. The method according to claim 1, wherein said user credentials include at least one of:
a username;
an email address;
a telephone number; and
a user supplied password.

14. The method according to claim 1, wherein derivation of passwords from said user credentials involves a non-reversible hashing process.

15. The method according to claim 1, wherein derivation of passwords from said user credentials involves a one-way encryption process.

16. The method according to claim 1, wherein a passphrase specific to an implementation of said method is involved in one or more of:
generation of said private key decryption key; and
creation of said first password.

17. A method for using user supplied credentials for authentication and decryption, the method comprising:
receiving user supplied credentials, said user supplied credentials;
deriving a first password from said user supplied credentials;
authenticating a user and said client device to a server using said first password by way of a login and authentication process;
at said client device, deriving a private key decryption key from said user supplied credentials and decrypting an encrypted private key using said private key decryption key, said encrypted private key being downloaded to said client device from said server;
wherein
said encrypted private key is undecryptable by said server;
said encrypted private key can only be decrypted using said private key decryption key;
said decrypted private key is only ever used by said client device.

18. The method according to claim 17, further comprising downloading to said client device encrypted data from a data server and decrypting said encrypted data using said decrypted private key.

19. The method according to claim 17, wherein at least one of said login and said authentication process is a zero-knowledge process.

20. The method according to claim 17, wherein derivation of passwords from said user credentials involves a non-reversible hashing process.

21. The method according to claim 17, wherein derivation of passwords from said user credentials involves a one-way encryption process.

22. The method according to claim 17, wherein a passphrase specific to an implementation of said method is involved in one or more of:
generation of said private key decryption key; and
creation of said first password.

23. The method according to claim 1, wherein said method involves at least one or more of:
Human Interactive Proof (HIP); and
a Turing Test being used to prove that a user is human.

24. The method according to claim 1, wherein said method involves a salt provided by a server for use by a client during a hashing process.

25. The method according to claim 1, wherein said method involves at least one of:
a single sign-on (SSO) method; and
a single sign-on (SSO) method using user supplied credentials to create a session for a user device.

26. The method according to claim 1, wherein said method involves two-factor authentication (2FA).

27. The method according to claim 1, wherein said method involves at least one one-time token (OTT).
